(19) United States
(12) Patent Application Publication
(10) Pub. No.: US 2014/0232964 A1
(43) Pub. Date: Aug. 21, 2014

(54) INTEGRATED GATE DRIVER CIRCUIT AND LIQUID CRYSTAL PANEL

(71) Applicant: HANNSTAR DISPLAY CORP., NEW TAIPEI CITY (TW)

(72) Inventors: Chun-Chin TSENG, Kaohsiung City (TW); Ya-Wen LEE, Tainan City (TW); Kuo-Wen PAN, Kaohsiung City (TW); Chien-Ting CHAN, Tainan City (TW)

(73) Assignee: HANNSTAR DISPLAY CORP., NEW TAIPEI CITY (TW)

(21) Appl. No.: 14/192,243

(22) Filed: Feb. 27, 2014

Related U.S. Application Data
(63) Continuation-in-part of application No. 13/771,806, filed on Feb. 20, 2013.

(51) Int. Cl. G02F 1/133

(52) U.S. Cl. CPC G02F 1/13306
USPC 349/42

(57) ABSTRACT

An integrated gate driver circuit includes a control circuit, a plurality of drive stages and a plurality of discharge transistors. The control circuit is configured to output a plurality of clock signals within a frame period and to output a discharge enabling signal within a blanking period of the frame period. Each of the drive stages receives the clock signals and includes an output terminal configured to output a gate driving signal. Each of the discharge transistors is coupled to the output terminal of one of the drive stages and discharges the output terminal according to the discharge enabling signal thereby eliminating the voltage fluctuation of the output terminal in the blanking period.

### CROSS REFERENCE TO RELATED APPLICATION

This application is a continuation-in-part application of U.S. Ser. No. 13/771,806, filed on Feb. 20, 2013 and claims the priority benefit of Chinese Patent Application Number 201210198895.5, filed on Jun. 14, 2012, the full disclosure of which is incorporated herein by reference.

### BACKGROUND

1. Field of the Disclosure

This disclosure generally relates to a liquid crystal display and, more particularly, to an integrated gate driver circuit and a liquid crystal panel using the same.

2. Description of the Related Art

The conventional liquid crystal display generally includes a plurality of gate driver circuits configured to drive a pixel matrix. In order to reduce the manufacturing cost and to efficiently use the substrate space, gate drivers and the pixel matrix can both be formed on the substrate surface, wherein said gate drivers are named the integrated gate driver circuit.

Referring to FIG. 1, it shows a schematic block diagram of the conventional integrated gate driver circuit 9 including a control circuit 91 and a plurality of drive stages 92₁-92₄ . . . . The control circuit 91 outputs a plurality of clock signals CLK to the drive stages 92₁-92₄ . . . , and the clock signals CLK include, for example, CLK1-CLK4, refer to FIG. 2. The drive stages 92₁-92₄ . . . respectively output an output signal Output 1-Output 4 . . . for driving one gate line.

Referring to FIG. 2, it shows a timing diagram of the clock signals and the output signals of the integrated gate driver circuit 9 shown in FIG. 1. Firstly the control circuit 91 outputs a start vertical frame signal STV to the first drive stage 92₁ and then sequentially outputs a part of the clock signals CLK1-CLK4 (e.g. CLK1-CLK3) to every drive stage. After receiving a part of the clock signals CLK, the first drive stage 92₁ outputs an output signal Output 1, which is a replica of the first waveform of the clock signal CLK1; after receiving a part of the clock signals CLK the second drive stage 92₂ outputs an output signal Output 2, which is a replica of the first waveform of the clock signal CLK2; after receiving a part of the clock signals CLK the fifth drive stage 92₅ outputs an output signal Output 3, which is a replica of the second waveform of the clock signal CLK1; after receiving a part of the clock signals CLK the sixth drive stage 92₆ outputs an output signal Output 4, which is a replica of the second waveform of the clock signal CLK2; and so on.

In order to reduce the power consumption of the integrated gate driver circuit 9, the control circuit 91 will stop outputting any clock signal to the drive stages 92₁-92₄ . . . between two image frames; that is, in a time interval after the last drive stage outputs an output signal Output n of a first image frame and before the first drive stage 92₁ outputs an output signal Output 1 of a second image frame, referring to FIG. 3, the control circuit 91 does not output any clock signal. However, during the time interval that the drive stages 92₁-92₄ . . . do not receive any clock signal, the voltage value of the output signals Output 1-Output n . . . may have the voltage fluctuation as shown in FIG. 3, and this voltage fluctuation can influence the gate driving signals in the second image frame.

Accordingly, the present disclosure further provides an integrated gate driver circuit and a liquid crystal panel that can eliminate the voltage fluctuation on the gate lines in a blanking period between two image frames.

### SUMMARY

The present disclosure provides an integrated gate driver circuit and a liquid crystal panel that utilize a plurality of discharge transistors to discharge every gate line within the blanking period between two frame periods thereby eliminating the voltage fluctuation on the gate lines in the blanking period.

The present disclosure further provides an integrated gate driver circuit and a liquid crystal panel that generate a discharge enabling signal within the blanking period between two frame periods so as to discharge the gate lines.

The present disclosure provides an integrated gate driver circuit includes a control circuit, a drive stage and a discharge transistor. The control circuit is configured to output a plurality of clock signals within a frame period and output a discharge enabling signal within a blanking period. The drive stage receives the clock signals and includes an output terminal configured to output a gate driving signal. The discharge transistor is coupled to the output terminal of the drive stage and configured to discharge the output terminal according to the discharge enabling signal.

The present disclosure further provides a liquid crystal panel includes a substrate, a thin film transistor matrix and an integrated gate driver circuit. The thin film transistor matrix is formed on the substrate and has a plurality of gate lines. The integrated gate driver circuit is formed on the substrate and configured to drive the thin film transistor matrix. The integrated gate driver circuit includes a control circuit, a drive stage and a discharge transistor. The control circuit is configured to output a plurality of clock signals within a frame period and output a discharge enabling signal within a blanking period. The drive stage receives the clock signals and includes an output terminal configured to output a gate driving signal. The discharge transistor is coupled to the output terminal of the drive stage and configured to discharge the output terminal according to the discharge enabling signal.

The present disclosure further provides an integrated gate driver circuit includes a control circuit and a drive stage. The control circuit is configured to output a plurality of clock signals within a frame period and output a discharge enabling signal within a blanking period. The drive stage receives the clock signals, and has an output terminal configured to output a gate driving signal and a discharge transistor coupled to the output terminal and configured to discharge the output terminal according to the discharge enabling signal.

In one aspect, each of the drive stages includes an operating transistor having a control terminal, a first terminal and a second terminal. The control terminal receives the clock signals. The first terminal or the second terminal is coupled to the output terminal.

In one aspect, the blanking period is a time interval after the gate driving signal outputted by a last drive stages of the plurality of drive stages and before a next start vertical frame signal; and preferably, the blanking period is between a falling edge of the gate driving signal outputted by the last drive stage of the plurality of drive stages and a rising edge of the next start vertical frame signal.

In one aspect, the control circuit has a negative voltage source configured to output a negative voltage. The first terminal of the discharge transistor is coupled to the terminal; the second of the discharge transistor is coupled to the negative voltage source; and the control terminal of the discharge transistor receives the discharge enabling signal.

In one aspect, a signal duration of the discharge enabling signal is smaller than or equal to the blanking period.

In the integrated gate driver circuit and a liquid crystal panel according to the embodiment of the present disclosure, as the control circuit does not output any clock signal to the drive stages within the blanking period, the derive stages are floated to caused the voltage rise on the output terminal. Therefore, the present disclosure utilizes the discharge enabling signal to discharge the output terminal of every drive stage within the blanking period so as to eliminate the voltage fluctuation on the output terminal and the gate lines of the liquid crystal panel within the blanking period.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic block diagram of the conventional integrated gate driver circuit.

FIG. 2 shows a timing diagram of the integrated gate driver circuit shown in FIG. 1.

FIG. 3 shows a schematic diagram of output signals of the first drive stage and the last drive stage of the conventional integrated gate driver circuit.

FIGS. 4A and 4B respectively show a schematic diagram of the liquid crystal panel and the integrated gate driver circuit according to an embodiment of the present disclosure.

FIG. 5A shows a timing diagram of the integrated gate driver circuit according to the embodiment of the present disclosure.

FIG. 5B shows a circuit diagram of one drive stage of the integrated gate driver circuit according to the embodiment of the present disclosure.

FIG. 5C shows an operational schematic diagram of the drive stage shown in FIG. 5B, wherein the drive stage is a first drive stage.

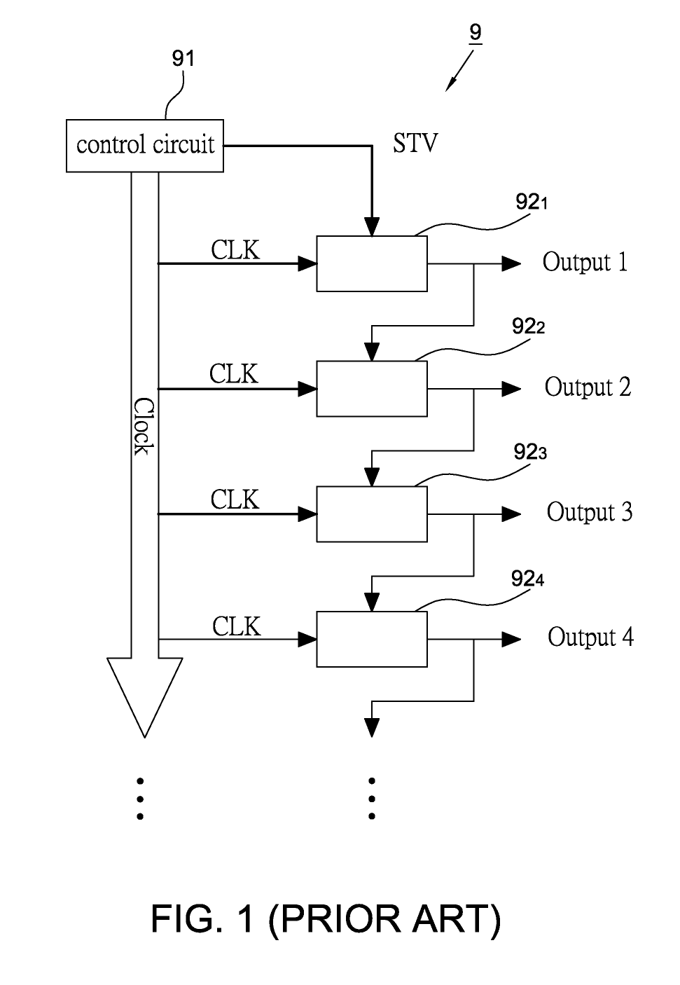

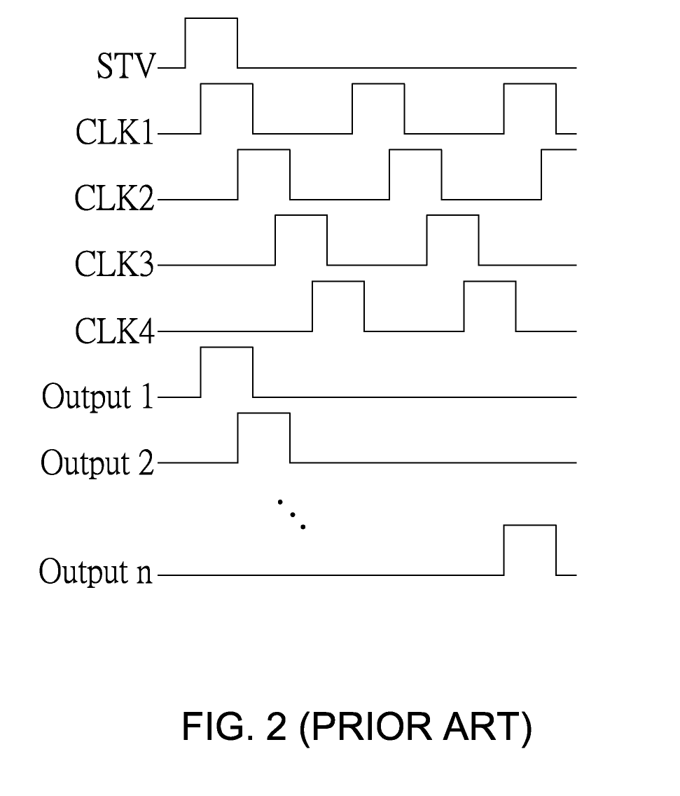

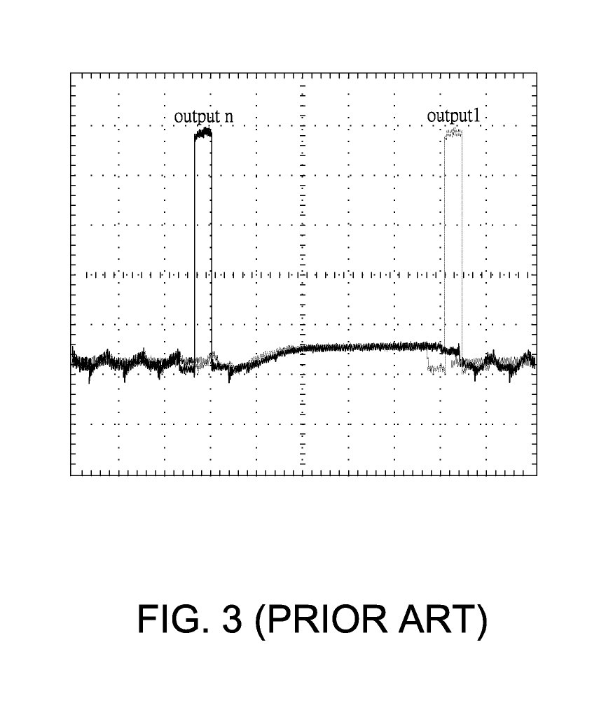

### DETAILED DESCRIPTION OF THE EMBODIMENT

It should be noted that, wherever possible, the same reference numbers will be used throughout the drawings to refer to the same or like parts.

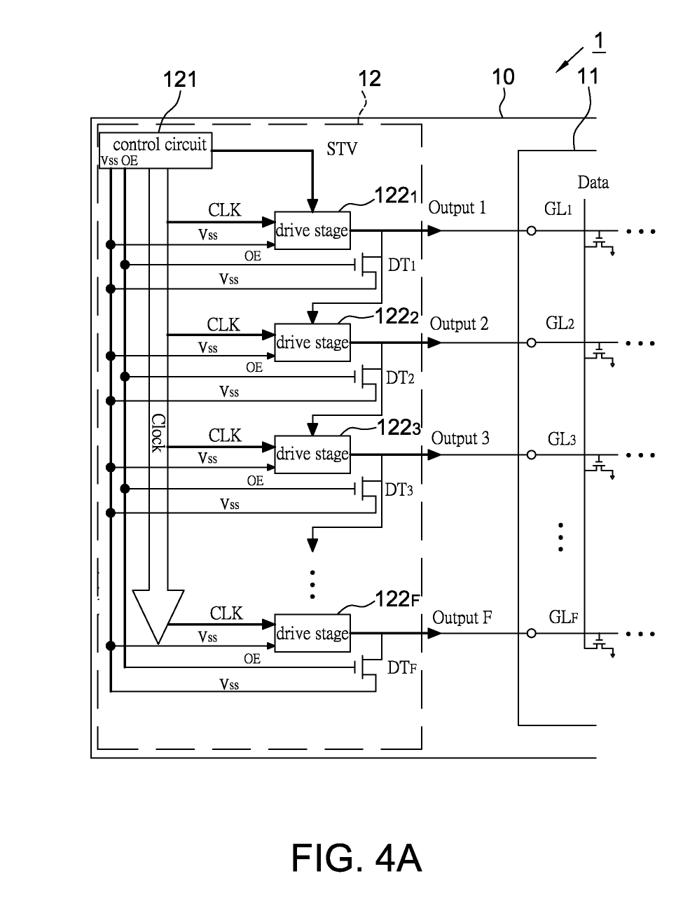

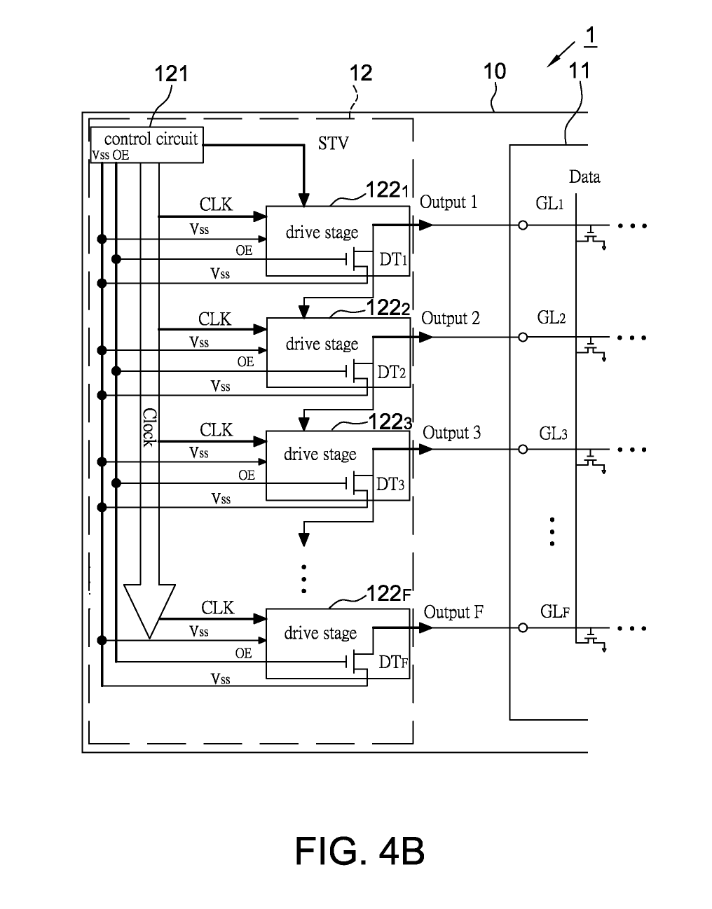

Referring to FIG. 4A, it shows a schematic block diagram of the liquid crystal panel according to an embodiment of the present disclosure. The liquid crystal panel 1 includes a substrate 10, a thin film transistor matrix 11 and an integrated gate driver circuit 12. The substrate 10 may be a glass substrate or a flexible substrate for forming a thin film transistor matrix in general liquid crystal panels, wherein the thin film transistor matrix may be an oxide thin film transistor matrix including a plurality of oxide thin film transistors arranged in matrix. In one embodiment, the oxide thin film transistor matrix may be an IGZO (indium gallium zinc oxide) thin film transistor matrix including a plurality of IGZO thin film transistors arranged in matrix, e.g. an enhancement mode IGZO thin film transistor matrix or a depletion mode IGZO thin film transistor matrix.

The thin film transistor matrix 11 is formed on the substrate 10 and includes a plurality of gate lines GL₁-GL_{F} respectively connected to a row of thin film transistors, wherein the method of forming a thin film transistor matrix on a substrate is well know and recorded in documents and thus details thereof are not described herein.

The integrated gate driver circuit 12 is formed on the substrate 10 together with the thin film transistor matrix 11 and configured to drive the thin film transistor matrix 11. The integrated gate driver circuit 12 includes a control circuit 121, a plurality of drive stages 122₁-122_{F} and a plurality of discharge transistors DT₁-DT_{F}, wherein the first terminal of the discharge transistors DT₁-DT_{F} is respectively connected to the drive stages 122₁-122_{F}.

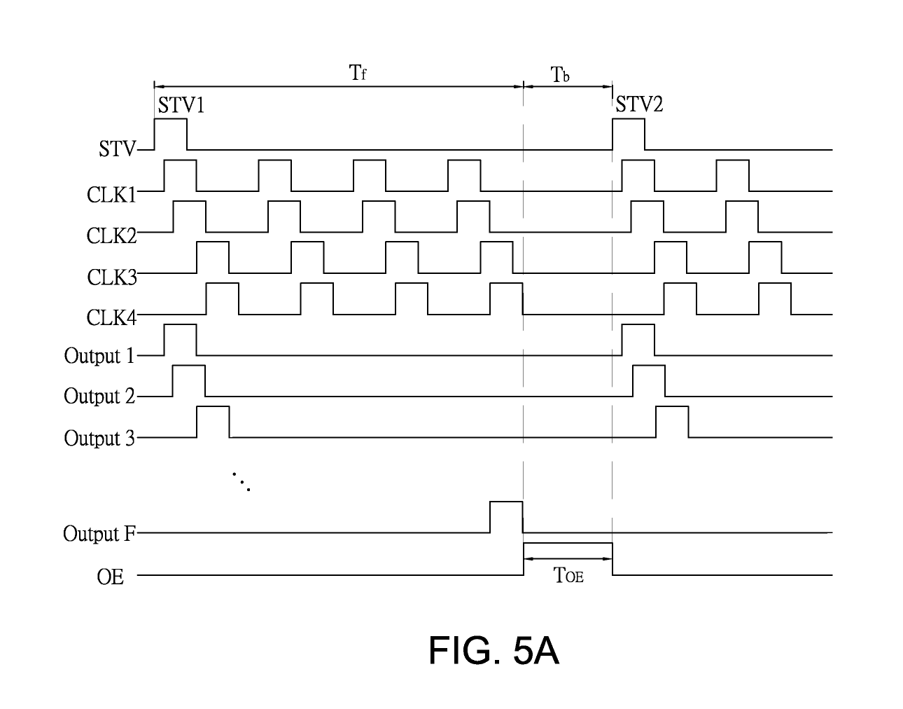

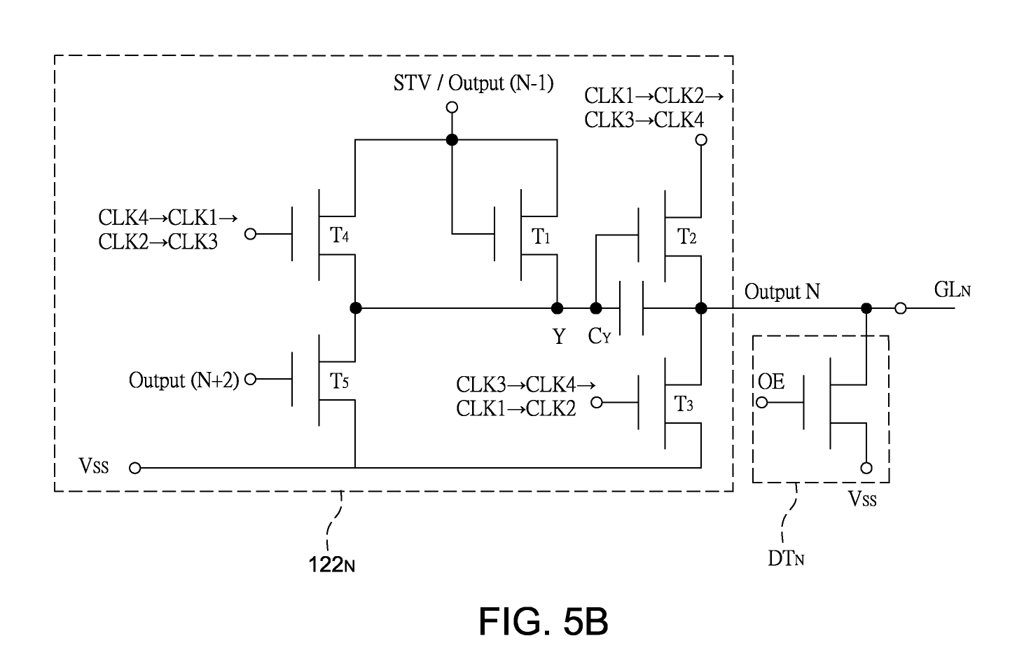

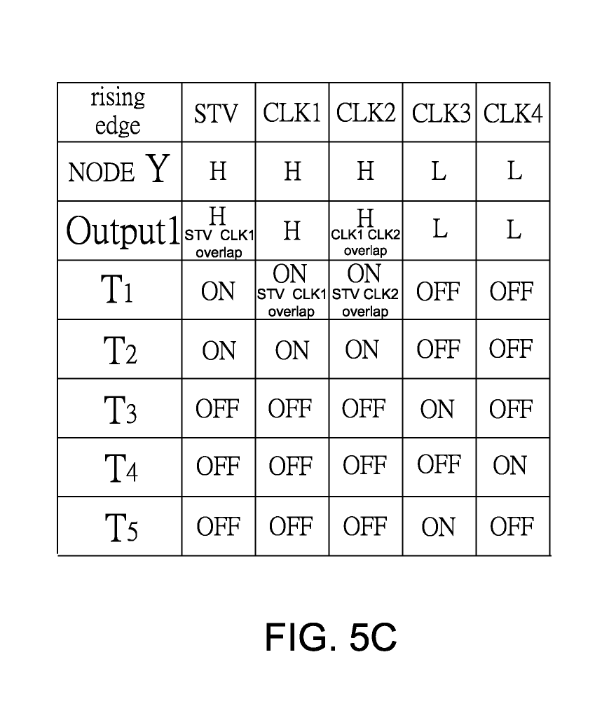

Further referring to FIG. 5A, the control circuit 121 is configured to output a plurality of clock signals CLK within a frame period T_{f} and output a discharge enabling signal or an output enable signal OE within a blanking period T_{b}, wherein the control circuit 121 does not output the clock signals CLK within the blanking period T_{b}. The control circuit 121 further includes a negative voltage source configured to provide a negative voltage V_{SS} (or a low voltage, for example −5 volts to −10 volts, but not limited to) to each of the drive stages 122₁-122_{F} and each of the discharge transistors DT₁-DT_{F}. In another embodiment, the negative voltage or the low voltage provided to the drive stages 122₁-122_{F} may be different from that provided to the discharge transistors DT₁-DT_{F}.

Each of the drive stages 122₁-122_{F} receives the clock signals CLK and has an output terminal, and the drive stages 122₁-122_{F} respectively output a gate driving signal Output 1-Output F to one of the gate lines GL₁-GL_{F}. It is appreciated that each of the gate lines GL₁-GL_{F} is configured to drive a row of thin film transistors of the thin film transistor matrix 11.

Each of the discharge transistors DT₁-DT_{F} is coupled to the output terminal of one of the drive stages 122₁-122_{F} and one of the gate lines GL₁-GL_{F}, and configured to discharge the output terminal and the associated gate lines GL₁-GL_{F} according to the discharge enabling signal OE. Each of the discharge transistors DT₁-DT_{F} includes a first terminal, a second terminal and a control terminal, wherein the first terminal is coupled to the output terminal and one of the gate lines GL₁-GL_{F}; the second terminal is coupled to the negative voltage V_{SS}; and the control terminal receives the discharge enabling signal OE so as to accordingly discharge the output terminal and the associated gate lines GL₁-GL_{F}; that is, when the control terminal receives the discharge enabling signal OE, the discharge transistors DT₁-DT_{F} are turned on so as to discharge the output terminal and the associated gate lines GL₁-GL_{F} via the second terminal, e.g. discharging to the negative voltage V_{SS} herein. In the embodiment of the present disclosure, the discharge transistors DT₁-DT_{F} may be thin film transistors that are formed on the substrate 10 together with the drive stages 122₁-122_{F} and the thin film transistor matrix 11. In another embodiment, the discharge transistors DT₁-DT_{F} may be respectively included in the drive stages 122₁-122_{F} as shown in FIG. 4B. In this embodiment, each of the discharge transistors DT₁-DT_{F} is coupled to one of the gate lines GL₁-GL_{F} through the output terminal of one of the drive stages 122₁-122_{F}, and configured to discharge the associated gate lines GL₁-GL_{F} according to the discharge enabling signal OE. Each of the discharge transistors DT₁-DT_{F} includes a first terminal, a second terminal and a control terminal, wherein the first terminal is coupled to one of the gate lines GL₁-GL_{F} through the output terminal; the second terminal is coupled to the negative voltage V_{SS}; and the control terminal receives the discharge enabling signal OE so as to accordingly discharge the associated gate lines GL₁-GL_{F}; that is, when the control terminal receives the discharge enabling signal OE, the discharge transistors DT₁-DT_{F} are turned on so as to discharge the associated gate lines GL₁-GL_{F} via the second terminal to the negative voltage V_{SS}.

Referring to FIG. 5A, it shows a timing diagram of the clock signals CLK1-CLK4 and the output signals Output 1-Output F of the integrated gate driver circuit according to the embodiment of the present disclosure. In the beginning of every frame period T_{f}, the control circuit 121 first outputs a start vertical frame signal STV (e.g. STV1 and STV2) to a first drive stage 122₁ of the plurality of drive stages, wherein the frame period T_{f} is referred to a time interval that the integrated gate driver circuit 12 drives the gate lines GL₁-GL_{F} once. Between two adjacent frame periods, as the control circuit 121 does not output any clock signal and does not drive any gate line in a time interval, this time interval is referred to the blanking period T_{b} herein.

The blanking period T_{b} is a time interval after a last drive stage 122_{F} of the plurality of drive stages outputting the gate driving signal Output F and before a next start vertical frame signal STV2; preferably, the blanking period T_{b} is between a falling edge of the gate driving signal Output F outputted by the last drive stage 122_{F} and a rising edge of the next start vertical frame signal STV2.

The integrated gate driver circuit and the liquid crystal panel according to the embodiment of the present disclosure generate the discharge enabling signal OE to the discharge transistors DT₁-DT_{F} within the blanking period T_{b} so as to discharge the output terminal and the gate lines GL₁-GL_{F} through the discharge transistors DT₁-DT_{F}. Therefore, a signal duration T_{OE} of the discharge enabling signal OE is preferably smaller than or equal to the blanking period T_{b}.

Referring to FIG. 5B, it shows a circuit diagram of the Nth drive stage 122_{N} and the Nth discharge transistor DT_{N} of the integrated gate driver circuit shown in FIG. 4A. The Nth drive stage 122_{N} includes a first transistor T₁, a second transistor T₂, a third transistor T₃, a fourth transistor T₄ and a fifth transistor T₅, wherein the transistors T₁-T₅ may be thin film transistors to be served as switching elements and formed on the substrate 10 together with the thin film transistor matrix 11 and the discharge transistors DT₁-DT_{F}. The output terminal of the Nth drive stage 122_{N} is coupled to the Nth discharge transistor DT_{N} and outputs a gate driving signal Output N to drive one gate line GL_{N}.

A first terminal of the first transistor T₁ is coupled to a control terminal of the first transistor T₁ and receives a start vertical frame signal STV or a gate driving signal Output (N−1) outputted by a previous drive stage 122_{N-1}. A second terminal of the first transistor T₁ is coupled to a node Y, wherein the node Y is coupled to the output terminal of the Nth drive stage 122_{N} and the gate line GL_{N} through a capacitor C_{Y}, which is configured to maintain the voltage on the node Y. In another embodiment, the capacitor C_{Y} may not be implemented.

A first terminal of the second transistor T₂ receives the clock signals CLK and a second terminal of the second transistor T₂ is coupled to the output terminal and the gate line GL_{N}. A control terminal of the second transistor T₂ is coupled to the node Y. In this embodiment, the first terminal may receive the clock signals in a sequence CLK1, CLK2, CLK3 and CLK4 shown in FIG. 5A.

A first terminal of the third transistor T₃ is coupled to the output terminal and the gate line GL_{N}. A control terminal of the third transistor T₃ receives the clock signals CLK and a second terminal of the third transistor T₃ is coupled to the negative voltage V_{SS}. In this embodiment, the control terminal may receive the clock signals in a sequence CLK3, CLK4, CLK1 and CLK2 shown in FIG. 5A.

A first terminal of the fourth transistor T₄ is coupled to the first terminal and the control terminal of the first transistor T₁ so as to receive the start vertical frame signal STV or the gate driving signal Output (N−1) of the previous drive stage 122_{N-1}. A second terminal of the fourth transistor T₄ is coupled to the node Y, and a control terminal of the fourth transistor T₄ receives the clock signals CLK. In this embodiment, the control terminal may receive the clock signals in a sequence CLK4, CLK1, CLK2 and CLK3 shown in FIG. 5A.

A first terminal of the fifth transistor T₅ is coupled to the node Y. A second terminal of the fifth transistor T₅ is coupled to the negative voltage V_{SS} and a control terminal of the fifth transistor T₅ is coupled to a second next drive stage 122_{(N+2)} of the Nth drive stage 122_{N} to receive the gate driving signal Output (N+2).

Referring to FIG. 5C, it shows an operational schematic diagram of the drive stage shown in FIG. 5B, wherein the drive stage is a first drive stage herein.

In the first drive stage 122₁, the control circuit 121 outputs a start vertical frame signal STV1 to the first drive stage 122₁ at the beginning of one frame period T_{f}, and then the control circuit 121 sequentially outputs the clock signals CLK1, CLK2, CLK3 and CLK4 to the first drive stage 122₁ as shown in FIG. 5A. FIG. 5C shows the operating states of the transistors T₁-T₅ when sequentially receiving the start vertical frame signal STV1 and the clock signals CLK1-CLK4 and the voltages on the node Y and gate driving signal Output 1, wherein “H” indicates a digit value “1” and “L” indicates a digit value “0” and actual voltage values associated with “H” and “L” may be determined according to actual applications. For example in one embodiment, “H” may be +15 volts and “L” may be −5 volts, but not limited thereto.

In FIG. 5A, when the last drive stage 122_{F} outputs a gate driving signal Output F to drive the last gate line GL_{F} of the thin film transistor matrix 11, one frame period T_{f} is ended. Next, when the control circuit 121 sends another start vertical frame signal STV2, a next frame period T_{f} is started. More specifically speaking, the frame period T_{f} is a time interval that the integrated gate driver circuit 12 drives the gate lines GL₁-GL_{F} once; that is, a time interval between a rising edge of the start vertical frame signal STV and a falling edge of the gate driving signal Output F outputted by the last drive stage 122_{F}.

It should be mentioned that a circuit structure of every drive stage of the present disclosure is not limited to that shown in FIG. 5B as long as the circuit structure includes an operating transistor and an output terminal, and a control terminal of the operating transistor receives the clock signals CLK so as to discharge the output terminal and the gate line coupled to a first terminal or a second terminal of the operating transistor in at least a part of the frame period T_{f}. For example, the operating transistor in FIG. 5B is the third transistor T₃, and when the control terminal of the third transistor T₃ is turned on by the clock signals, the third transistor T₃ may discharge the output terminal coupled to the first terminal thereof and the associated gate line. It should be mentioned that charges on the output terminal are not limited to be discharged to the negative voltage V_{SS} or a low voltage through the operating transistor, and the charges may be discharged to a signal source of the clock signals in other embodiments. In the present disclosure, the drive stages of the integrated gate driver circuit may use any proper circuit structure as long as discharge transistors DT₁-DT_{F} are respectively disposed at the output terminal of every drive stage and the discharge enabling signal OE is send to the discharge transistors DT₁-DT_{F} within the blanking period T_{b} between two image frames so as to discharge the output terminals and the gate lines GL₁-GL_{F}. The blanking period T_{b} and/or the frame period T_{f} may be determined according to an actual size of the liquid crystal panel.

In the embodiment of the present disclosure, the thin film transistors T₁-T₅, which are served as switching elements, and the discharge transistors DT₁-DT_{F} mentioned above may be oxide thin film transistors. In one embodiment, the oxide thin film transistors may be IGZO (indium gallium zinc oxide) thin film transistors, e.g. enhancement mode IGZO thin film transistors or depletion mode IGZO thin film transistors.

As mentioned above, in the conventional integrated gate driver circuit the voltage fluctuation can occur on the gate line within a blanking period between two image frames so as to influence the image output. Therefore, the present disclosure further provides an integrated gate driver circuit and a liquid crystal display (FIGS. 4A and 4B) that utilize a discharge transistor to discharge the output voltage within a blanking period between two image frames so as to effectively eliminate the voltage fluctuation on the gate lines.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A liquid crystal panel, comprising:
a substrate;
a thin film transistor matrix formed on the substrate and comprising a plurality of gate lines;
an integrated gate driver circuit, formed on the substrate and configured to drive the thin film transistor matrix, the integrated gate driver circuit comprising:
a control circuit configured to output a plurality of clock signals within a frame period and output a discharge enabling signal within a blanking period;
a drive stage receiving the clock signals and comprising a plurality of oxide thin film transistors served as switching elements and an output terminal configured to output a gate driving signal; and
a discharge transistor coupled to the output terminal of the drive stage and configured to discharge the output terminal according to the discharge enabling signal, wherein the discharge transistor is an oxide thin film transistor.

2. The liquid crystal panel as claimed in claim 1, wherein the control circuit does not output the clock signals within the blanking period.

3. The liquid crystal panel as claimed in claim 1, wherein the control circuit comprises a negative voltage source configured to provide a negative voltage.

4. The liquid crystal panel as claimed in claim 3, wherein the negative voltage is provided to the drive stage.

5. The liquid crystal panel as claimed in claim 3, wherein the discharge transistor has a first terminal coupled to the output terminal, a second terminal coupled to the negative voltage source, and a control terminal receiving the discharge enabling signal.

6. The liquid crystal panel as claimed in claim 1, wherein the control circuit further outputs a start vertical frame signal to a first drive stage in the beginning of the frame period.

7. The liquid crystal panel as claimed in claim 6, wherein the blanking period is between the gate driving signal outputted by a last drive stage and a next start vertical frame signal.

8. The liquid crystal panel as claimed in claim 1, wherein a signal duration of the discharge enabling signal is smaller than or equal to the blanking period.

9. The liquid crystal panel as claimed in claim 1, wherein one of the oxide thin film transistors of the drive stage has a control terminal receiving the clock signals and a terminal coupled to the output terminal.

10. The liquid crystal panel as claimed in claim 1, wherein the oxide thin film transistors are indium gallium zinc oxide thin film transistors.

11. The liquid crystal panel as claimed in claim 10, wherein the indium gallium zinc oxide thin film transistors are enhancement mode indium gallium zinc oxide thin film transistors or depletion mode indium gallium zinc oxide thin film transistors.

12. An integrated gate driver circuit adapted to a liquid crystal panel comprising a substrate and a thin film transistor matrix formed on the substrate, the integrated gate driver circuit being formed on the substrate and configured to drive the thin film transistor matrix, the integrated gate driver circuit comprising:
a control circuit configured to output a plurality of clock signals within a frame period and output a discharge enabling signal within a blanking period; and
a drive stage receiving the clock signals, and comprising a plurality of oxide thin film transistors served as switching elements, an output terminal configured to output a gate driving signal and a discharge transistor coupled to the output terminal and configured to discharge the output terminal according to the discharge enabling signal, wherein the discharge transistor is an oxide thin film transistor.

13. The integrated gate driver circuit as claimed in claim 12, wherein the oxide thin film transistors are indium gallium zinc oxide thin film transistors.

14. The integrated gate driver circuit as claimed in claim 13, wherein the indium gallium zinc oxide thin film transistors are enhancement mode indium gallium zinc oxide thin film transistors or depletion mode indium gallium zinc oxide thin film transistors.

15. The liquid crystal panel as claimed in claim 12, wherein the control circuit does not output the clock signals within the blanking period.

16. The liquid crystal panel as claimed in claim 12, wherein the control circuit comprises a negative voltage source configured to provide a negative voltage to the drive stage.

17. The liquid crystal panel as claimed in claim 12, wherein the control circuit further outputs a start vertical frame signal to a first drive stage in the beginning of the frame period.

18. The liquid crystal panel as claimed in claim 17, wherein the blanking period is between the gate driving signal outputted by a last drive stage and a next start vertical frame signal.

19. The liquid crystal panel as claimed in claim 12, wherein a signal duration of the discharge enabling signal is smaller than or equal to the blanking period.

20. The liquid crystal panel as claimed in claim 12, wherein one of the oxide thin film transistors of the drive stage has a control terminal receiving the clock signals and a terminal coupled to the output terminal.
